(19) United States
(12) Patent Application Publication
(10) Pub. No.: US 2011/0175390 A1
(43) Pub. Date: Jul. 21, 2011

(54) Retractable Tarp System with Automated Opening/Closing Mechanism

(75) Inventors: Lloyd Verduyn, Hamilton (CA); Peter Braun, Leamington (CA)

(73) Assignee: VTI Holdings, Inc., Detroit, MI (US)

(21) Appl. No.: 12/687,990

(22) Filed: Jan. 15, 2010

(51) Int. Cl. B60P 7/04

(52) U.S. Cl. 296/100.12

(57) ABSTRACT

A retractable tarp system having an automated air-operated closing mechanism used in conjunction with a headboard of a truck or vehicle-pulled trailer. The automated system of opening and closing the tarping system uses air cylinders to operate a guide for the front opening/closing mechanism, which can run off a trailer's air supply system. A hook extending from the tarp structure cooperates with the guide to secure the tarp structure to the headboard. The truck driver needs only to operate a switch to open and close the front closing mechanism of the retractable tarp system.

### FIELD OF THE DISCLOSURE

This disclosure relates to a retractable tarp system with an automated opening and closing mechanism. More specifically, the tarp system includes a release and tensioning system to operate the opening/closing mechanism in conjunction with a deck, such as on vehicle-pulled trailer.

### BACKGROUND

Trucks include rigid truck and trucks adapted to pull trailers, both enclosed and open, for transporting goods and materials. Certain trucks, sometimes called tractor units, are used to pull various types of open trailers, including flat bed, drop deck, double drops and RGNs. Items being shipped can readily be loaded on the deck or cargo bed of a trailer, which for certain goods can be loaded more easily than through a rear door of an enclosed fixed-wall trailer.

On flat bed trailers, fasteners, such as tie downs, can be used to hold freight, cargo and equipment during transport. Various types of straps, such a ratchet straps and winch straps, are used to tie down items being shipped on a trailer. Tie downs are often webbing outfitted with attachment hardware. Standard tie downs include feeding straps and chain through rail pockets or a rubber seal. Such tied down cargo or equipment can be exposed on the cargo bed or deck of a trailer.

Tarp systems for flat bed trailers include tarps placed over shipping items tied down by rubber straps or ropes. Preferably, flat bed trailers have retractable tarp systems that slide along tracks on each side of the flat bed deck, which may enclose the freight, cargo or equipment.

Flat bed tractor trailers having a retractable tarping system can transport a wide variety of freight, much of which freight cannot be loaded into conventional van-type transport trailers having in-situ walls and roof. The tarping system includes a tarpaulin supported by numerous vertically disposed frame members that span across the bed of the trailer and are attached at each of their opposite free ends to a respective trolley having rollers that engage an elongate track disposed along each side of the trailer. The trollies are manually urged along the elongate tracks to move the tarp system between its trailer enclosing configuration and its open configuration.

U.S. Pat. No. 6,065,796, which is incorporated herein by reference, discloses a track and trolley assembly for use with a tarpaulin enclosing system on a flat bed trailer defining a central longitudinal axis and having a bed portion defined by left and right lateral side edges. The track and trolley assembly comprises a plurality of trollies for operatively supporting the tarpaulin enclosing system, each trolley having a frame member, at least one weight-bearing roller mounted on the frame member for rotation about a substantially horizontal axis and at least one stabilizing roller mounted on the frame member for rotation about a substantially vertical axis. An elongate track has a length, a substantially vertical trailer mounting face, a substantially horizontal weight-bearing roller receiving surface disposed along the length of the elongate track, and at least one substantially vertical stabilizing roller receiving surface disposed along the length of the elongate track. A rail is disposed substantially along the length of the elongate track and has a length, a substantially vertical trailer mounting face, and a hook-receiving rail portion disposed in laterally outwardly projecting cantilever relation from the trailer mounting face so as to be free and clear of the substantially vertical trailer mounting face, and disposed above the substantially horizontal weight-bearing roller receiving surface of the elongate track and above the at least one substantially vertical stabilizing roller receiving surface of the elongate track, for receiving at least one tie-down hook in releasably retained relation therealong. The trollies move along the elongate track such that the frame members of the trollies are disposed horizontally outboard of the hook-receiving rail portion of the rail.

Trucks and trailers often have air cylinders of compressed air systems to operate air brake or other systems. Trucks also have hydraulic systems. These pneumatic and hydraulic systems have not been integrated with flatbed, drop deck, double drops and RGN trailer tarp systems.

### SUMMARY

The present disclosure provides a retractable tarp system with an automated front or rear closing mechanism. The retractable tarp system includes a tarp structure adapted to slide or roll on a track on a side of the deck to enclose cargo on the deck. The tarp system includes a release and tensioning system using air or hydraulics to operate the front opening/closing mechanism in conjunction with a headboard of a truck or a vehicle-pulled trailer for a front system.

The automated system of opening and closing the tarping system preferably uses air cylinders to operate a guide for a front opening/closing mechanism. An air cylinder has a piston rod attached to the guide or attachment means; wherein an attachment means, such as a guide, is slideable relative to the tarp structure. A hook can extend from the tarp structure with an end that engages the guide so the hook cooperates with the guide to secure the tarp structure to the headboard. Air cylinders can run off a trailer's compressed air supply system.

A truck driver needs only to operate a switch, such as a toggle, to open and close the closing mechanism of the retractable tarp system. A system can have the air cylinder hooked up to a rod with an upper and lower hook that connects to two receiving devices on the tarp structure.

### BRIEF DESCRIPTION OF THE DRAWINGS

The above-mentioned and other features of this disclosure and the manner of obtaining them will become more apparent, and the disclosure itself will be best understood by reference to the following descriptions of systems taken in conjunction with the accompanying figures, which are given as non-limiting examples only, in which:

FIG. 1 shows a rear end elevational view of a prior art flat bed trailer having a retractable tarp system, with the tarp system drawn over the trailer enclosing freight;

FIG. 2 shows a side elevational view of the prior art flat bed trailer having a retractable tarp system;

FIG. 3 shows a perspective view of an open front closing mechanism of a retractable tarp system;

FIG. 4 shows a perspective view of a closed front closing mechanism of a retractable tarp system;

FIG. 5 shows a perspective view of a guide engaging a notch of a hook inside a channel; and

FIG. 6 shows a perspective view of an adjustable latch as the guide.

The exemplifications set out herein illustrate embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiments in different forms, the figures show, and herein described in detail, embodiments with the understanding that the present descriptions are to be considered exemplifications of the principles of the disclosure and are not intended to be exhaustive or to limit the disclosure to the details of construction and the arrangements of components set forth in the following description or illustrated in the figures.

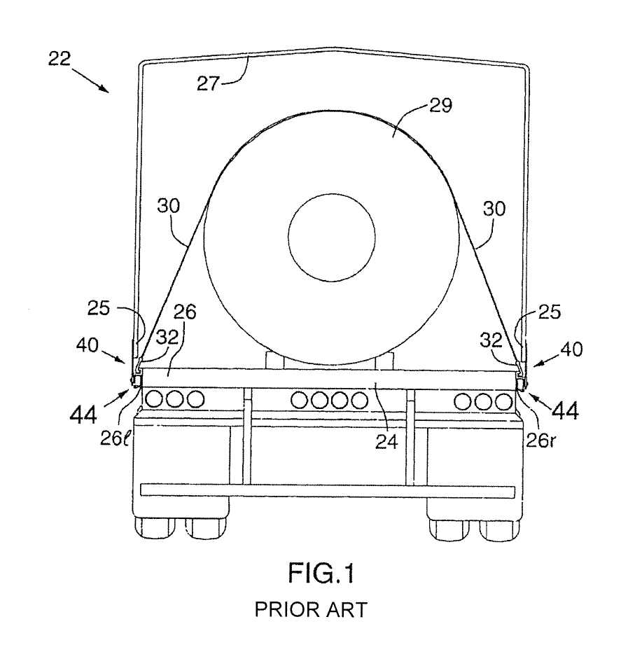

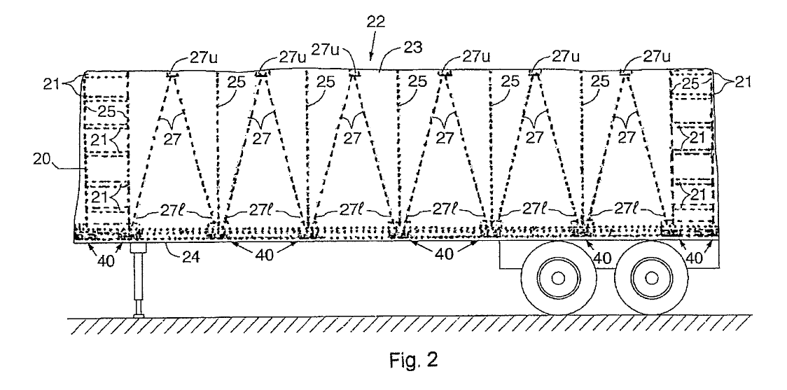

FIGS. 1 and 2 show a headboard 20 generally known in the art associated with a retractable tarp structure 22 both on a truck or a vehicle-pulled trailer, preferably a flat bed trailer 24. A flat bed trailer 24 has a bed portion 26 laterally defined by left 26-l and right 26-r outwardly facing lateral side edges. The tarp structure 22 includes a pliable fabric tarp 23, such as 20 oz. vinyl with an acrylic finish, mounted on and supported by a plurality of inverted “U”-shaped rib members 25, which preferably have 6″ curve on cast aluminum corners for strength and aerodynamics. Adjacent rib members 25 are operatively interconnected by spar members 27 pivotally connected at their lower ends 27-l to trollies 40. Preferred tarp lifters can be connected to bows, not the trollies, preferably with a plate forming a cart 42, adapted to move in a track 44, and are pivotally connected one to the next at their upper ends 27u. Tarp lifters sometimes are not connected at the top, but the meet the tarp and are wrapped in a sleeve to hold them in place. The two most forward and the two most rearward “U”-shaped rib members 25 can be respectively secured to each other by lateral re-enforcing ribs 21.

Tie-down straps 30 have a tie-down hook 32 disposed at each opposite end to hold to secure cargo or any load 29 to the bed portion or deck 26 of the flat bed trailer 24 or truck. Standard tie-down straps can be used. The tie down can also be built into the track 44, wherein the tied-down cargo 29 and straps 30 can be completed enclosed within the tarp structure 22.

Trollies 40 operatively support the tarp structure 22 that encloses the cargo 29. The trollies 40 are disposed along both the left 26-l and right 26-r side edges of the bed portion 26 of the flat bed trailer 24 or truck.

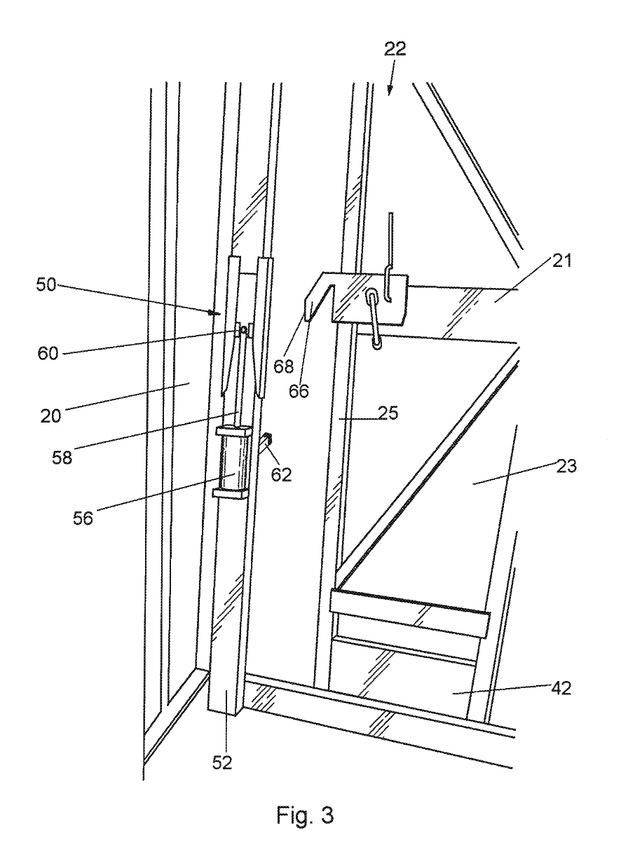

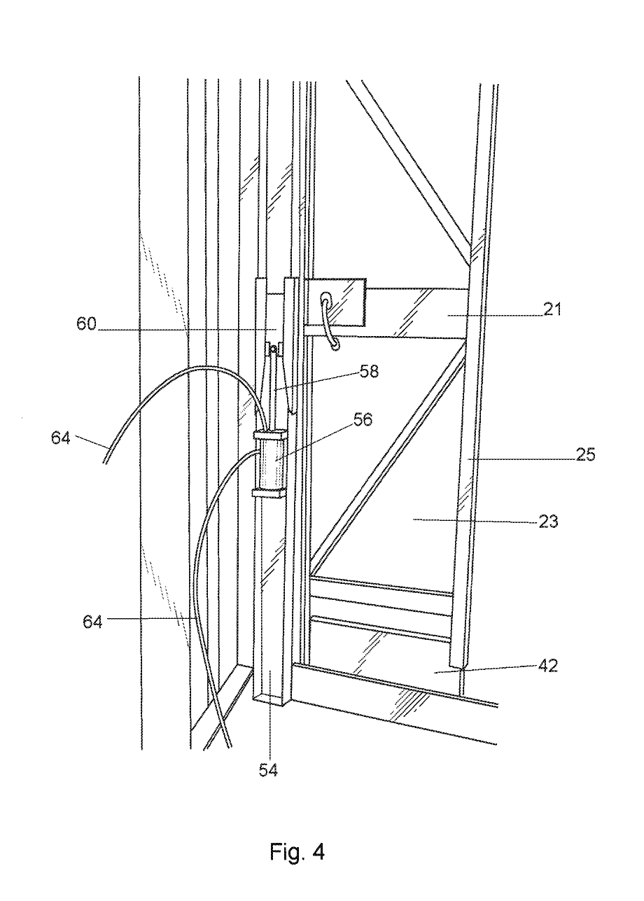

As shown in FIG. 3, a retractable tarp structure 22 includes an automated front closing mechanism 50, partially mounted on the headboard 20 of the trailer 24 or truck. The automated portion of the closing mechanism 50 is mounted on a beam 52 as shown in FIG. 3 or preferably a channel 54 as shown in FIGS. 4-6, such as a 5″×2.5″ channel that faces inward on each side of the headboard 20.

An air cylinder 56 can be mounted associated with the headboard 20. The air cylinder 56 may be a two-way air cylinder with a piston rod 58 that moves a guide 60 up and down. A guide 60 is generally one half of a complementary attachment means. The front closing mechanism 50 has a switch 62 to open and close the closing mechanism 50. The switch 62 may be a toggle, button or the like so that the driver needs only to operate a switch, such as a toggle, to open and close the retractable tarp structure 22. In the toggle example, the driver only has to pull a toggle switch to open the closing mechanism 50 and push the toggle to close the closing mechanism 50 of a retractable tarp structure 22 without climbing on the trailer 24.

The automated closing mechanism 50 can use air cylinders 56, which preferably employ the trailer's own air supply via lines 64, which may be internal per FIG. 3. As such, the air cylinder 56 is connected to a compressed air source on the trailer 24 or a truck. High pressure air lines 64 can run from the compressed air source to the air cylinder 56. Also an automated closing mechanism 50 can be run by hydraulics, using corresponding hydraulic systems similar to the air systems described herein in detail. It could also be done using electric motors.

The tarp structure 22 as shown has an attachment hook 66 mounted on a reinforcing rib 21 as an example with an end 68 that engages the guide 60, the hook 66 cooperates with the guide 60 on the piston rod 58 of the air cylinder 56 to secure the tarp structure 22 to the headboard 20. While the system as shown has the hook 66 on a portion of the cart 42 where the piston rod 58 goes up and down to lock or unlock the hook 66 to the headboard 20, it is also within the scope of this disclosure where the piston moves one or more hooks up and down on the front headboard, and the hooks are secured into the cart to lock the cart to the headboard.

FIG. 4 shows a perspective view of a closed closing mechanism 50 of a retractable tarp structure 22 that is primarily mounted in a channel 54 incorporated into the headboard 20 that is fixed to the trailer 24 or a truck. A two-way air cylinder 56 can be mounted on the headboard 20 at least partially within the channel 54, which is preferred to have channels 54 on each side of the headboard 20, each with an air cylinder 56. The air cylinder 56 has a piston rod 58 attached to a guide 60 that is slideable within the channel 54. The particular guide 60 can be a C-shaped channel bar adapted to slide up and down within the channel 54, of which only the back center portion of the channel bar is shown in FIG. 4. The rear leg of the C-shaped channel bar can be the portion that engages the hook 66. To aid the movement of the channel bar within the channel 54, the channel bar example of the guide 60 can have a UHMW cover. When air is applied to the air cylinder 56, the channel bar can slide with the UHMW covering up and down the channel 54.

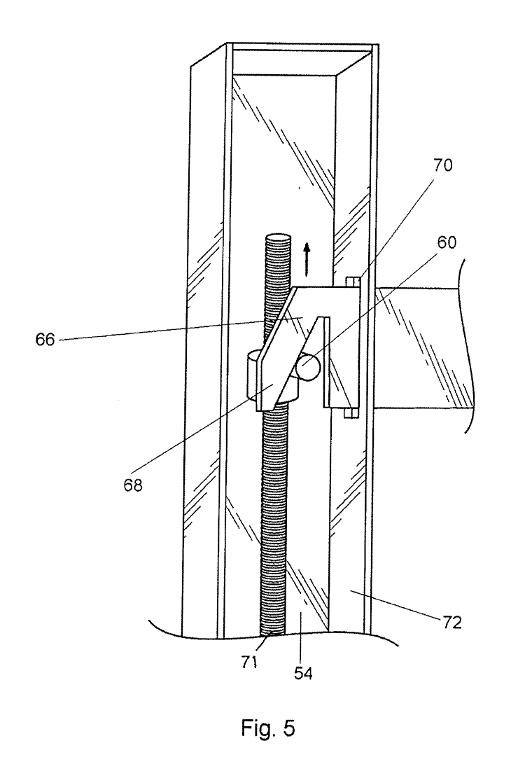

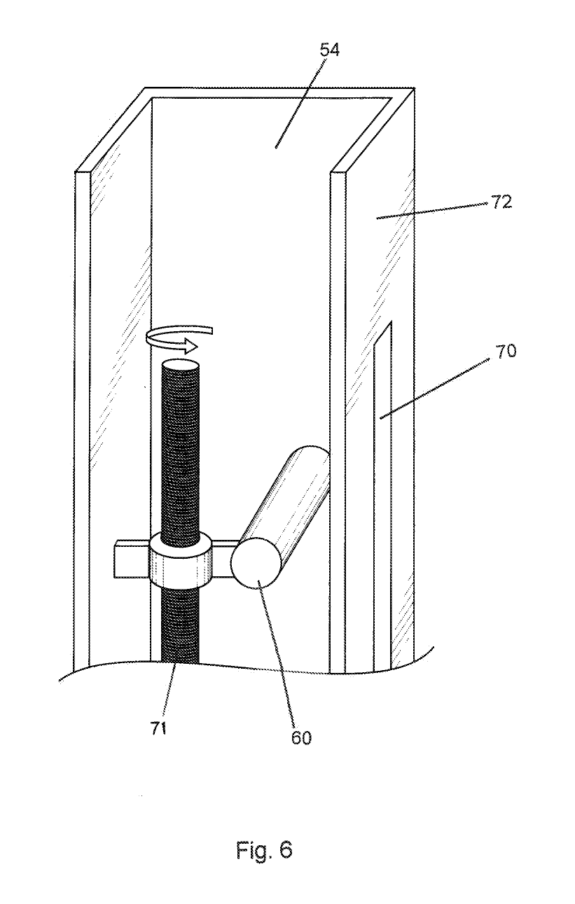

In the channel example, a slot 70 can be cut into the rear flange 72 of the channel 54 at the appropriate height for the hook 66 to pass through. The hook 66 is mounted on a portion of the tarp structure 22 so it lines up to pass through the slot 70, as shown in FIG. 5 passing through the slot 70 in the rear flange 72 of the channel 54. As shown in FIGS. 5 and 6, threaded rod 71 can be used to move a guide 60 (shown as a latch bar) up and down. This guide 60 can lock into a hook 66 that is on a portion of the cart 42. As a threaded rod is turned, the hook could also move up and down to catch or release corresponding recesses in a portion of the cart. The method could be extended to a system where a piston or threaded rod moves two hooks up and down, which can hook into the first cart to lock the cart to the headboard.

The hook 66 extends from the tarp structure 22 with an end 68 adapted to engage the guide 60, which may be a latch bar as shown in FIGS. 5 and 6. The hook 66 cooperates with the guide 60 on the piston rod 58 to secure the tarp structure 22 to the headboard 20. Preferably, the end 68 extends at a downward angle emanating from a top portion of the hook 66. This allows the hook 66 to be slightly pulled closed when the guide 60 slides upward.

In operation, the cart 42 with attached enforcing ribs 21 and rib members 25 is rolled in track 44 near the headboard 20 so the end 68 of the hook 66 on an enforcing rib 21 is adjacent to the beam 52 or channel 54 associated with the headboard 20, preferably through a slot 70 in a rear flange 72. Air pressure can be applied to the air cylinder 56 to cause the guide 60 to slide up the beam 52 or channel 54 and engage the hook 66 to fully close and secure the cart 42 and associated tarp structure 22 to the headboard 20 in a closed position. Compressed air from the air cylinder 56 drives the piston rod 58 causing the guide 60 to slide within the respective channel 54.

To open the tarp structure 22, air pressure can then be applied to the air cylinder 56, preferably the opposite end in a two-way air cylinder, to cause the guide 60 to slide down the beam 52 or channel 54 and disengage and release the hook 66. The cart 42 can then be rolled away from the headboard 20 to the back of the trailer 24 or truck to load or unload cargo 29 from the trailer 24 or truck.

The retractable tarp structure 22 can be opened, closed and secured from the ground for driver safety. The tarp 23 can cover or uncover cargo 29 in a few minutes with the switch 62 to simply open and close the closing mechanism 50 to save dock time. The closing mechanism 50 is self-contained so no special tools are necessary.

This disclosure focuses an automated front system that is air-operated, but the principals of this disclosure can be used with hydraulic systems and systems for the rear of the trailer.

The retractable tarp structure 22 is best suited for a flat bed trailer 24, but it can be used on flat bed trucks or portions of other vehicle-pulled trailers wherein the tarp structure 22 is secured to a headboard 20 with various slider side tarping systems.

This disclosure has been described as having exemplary embodiments and is intended to cover any variations, uses, or adaptations using its general principles. It is envisioned that those skilled in the art may devise various modifications and equivalents without departing from the spirit and scope of the disclosure as recited in the following claims. Further, this disclosure is intended to cover such variations from the present disclosure as come within the known or customary practice within the art to which it pertains.

What is claimed is:

1. A retractable tarp system with an automated air-operated closing mechanism used in conjunction with a truck or trailer having a deck with two sides and a front and rear end, the tarp system comprising:
the automated air-operated closing mechanism at an end of the deck;
a tarp structure adapted to slide on the sides of the deck,
an air cylinder with a piece that is slideable relative to the tarp structure,
an attachment hook fixed on the tarp structure that the piece engages, the attachment hook cooperates with the piece to secure the tarp structure to the trailer; and
a switch to operate the closing mechanism.

2. The tarp system of claim 1 wherein the air cylinder is connected to a compressed air source on the trailer.

3. A retractable tarp system including an automated air-operated front closing mechanism adapted to be used in conjunction with a truck or vehicle-pulled trailer having a headboard and a deck, the tarp system comprising:
a tarp structure adapted to slide on a track on a side of the deck,
an air cylinder mounted on the headboard; the air cylinder having a piston rod attached to a guide that is vertically slideable relative to the tarp structure,
a hook extending from the tarp structure with an end portion that the guide engages, the hook cooperates with the guide to secure the tarp structure to the headboard; and
a switch to operate the closing mechanism.

4. The tarp system of claim 3 wherein the air cylinder is connected to a compressed air source on the trailer.

5. The tarp system of claim 4 wherein air lines run from the compressed air source to the air cylinder.

6. The tarp system of claim 3 wherein the tarp structure is adapted to slide on tracks on each longitudinal side of the deck with air cylinders mounted on each side of the headboard.

7. The tarp system of claim 3 wherein the hook on an edge of the tarp structure has an end extending at a downward angle emanating from a top portion of the hook to allow the hook to be slightly pulled closed when the guide slides upward to engage the hook.

8. The tarp system of claim 3 wherein the air cylinder is a two-way air cylinder controlled by compressed air in each direction.

9. A retractable tarp system with an automated air-operated front closing mechanism used in conjunction with a truck or vehicle-pulled trailer having a headboard and a deck, the tarp system comprising:
a channel incorporated into each side of the headboard,
a tarp structure adapted to slide on tracks on each side of the deck,
an air cylinder mounted at least partially in each channel; each air cylinder having a piston rod attached to slide an attachment guide within the respective channel,
a cart panel slideable in each track having a hook mounted with an extending end portion that engages the guide,
the hook cooperates with the attachment guide to secure the tarp structure to the headboard; and
a switch to automatically close the front closing mechanism wherein compressed air from the air cylinder causes the guide to slide within the respective channel.

10. The tarp system of claim 9 wherein each channel has a rear flange with a slot at an appropriate height for the hook to pass through.

11. The tarp system of claim 9 wherein the air cylinder is connected to a compressed air source on the trailer.

12. The tarp system of claim 11 wherein air lines run from the compressed air source to the air cylinder.

13. The tarp system of claim 9 wherein the tarp structure is adapted to slide on tracks on each longitudinal side of the deck with air cylinders mounted on each side of the headboard.

14. The tarp system of claim 9 wherein the hook has an end extending at a downward angle emanating from a top portion of the hook to allow the hook to be slightly pulled closed when the guide slides vertically upward to engage the hook.

15. The tarp system of claim 9 wherein each air cylinder is a two-way air cylinder controlled by compressed air in each direction.
